(19) United States
(12) Patent Application Publication
(10) Pub. No.: US 2005/0000612 A1
(43) Pub. Date: Jan. 6, 2005

(54) Traction pad

(76) Inventor: Joseph Morgese, Daytona Beach, FL (US)

Correspondence Address: JOSEPH MORGESE, SUITE 606, PMB 389, 1500 BEVILLE ROAD, DAYTONA BEACH, FL, 32114, US

(21) Appl. No.: 10/823,743

(22) Filed: Aug. 23, 2004

Related U.S. Application Data
(60) Provisional application No. 60/536,234, filed on Jan. 14, 2004.
(60) Provisional application No. 60/462,810, filed on Apr. 14, 2003.

(51) Int. Cl. B60C 7/22

(52) U.S. Cl. 152/185

(57) ABSTRACT

An improved method for providing additional traction to vehicles during icy and snowy conditions. Especially in the Rocky Mountain states, where trucks are required to carry chains during the winter season, the Traction Pad (#6) provides a simpler and quicker alternative. The Traction Pads (#6) stack upon each other, are light-weight, and easily set upon the tires (#1), as they are shaped to the same contour as the tires (#1). Then, they are fastened to the belt (#3) that is already installed at the rim (#2), between the dual tire assembly (#1). The Traction Pad s (#6) ease of install and removal make them ideal in those situations, in wintery weather, on the side of a highway, where the sooner the truck-driver can get back in the warmth and safety of his/her cab, the better. Furthermore, this invention offers an alternative method for single tires based on the same principles for ease of handling and speed of installation and removal.

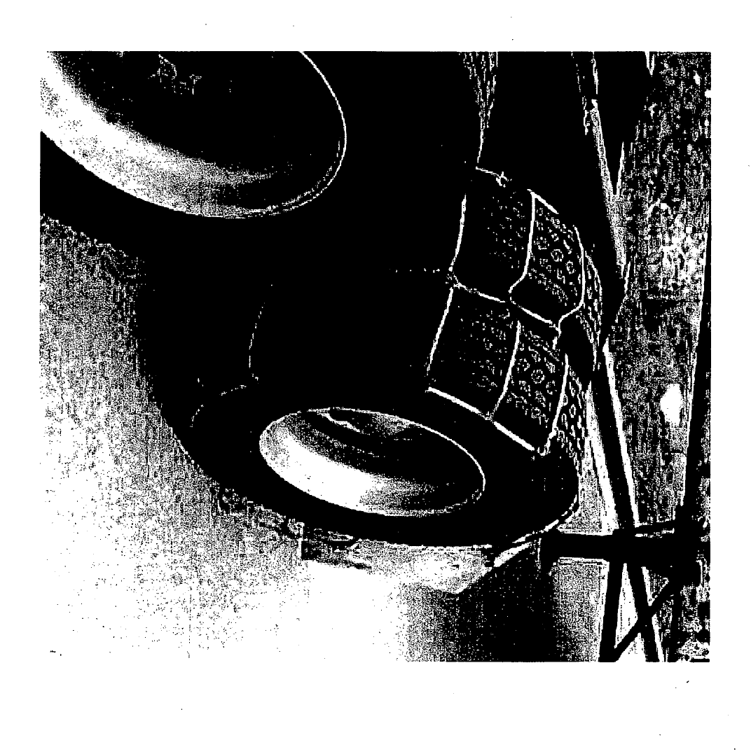

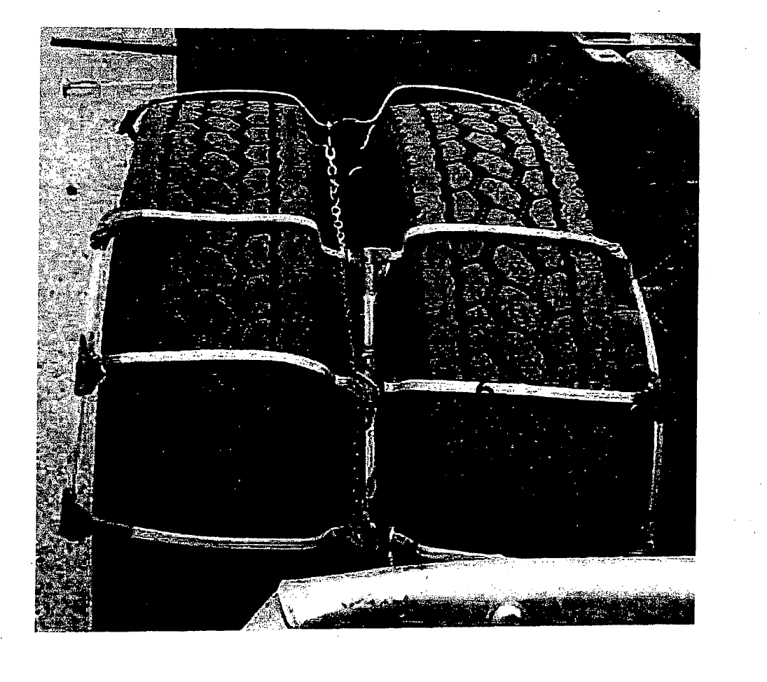

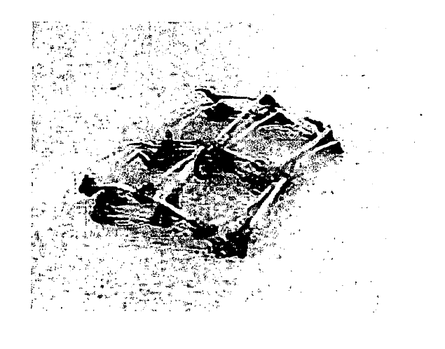

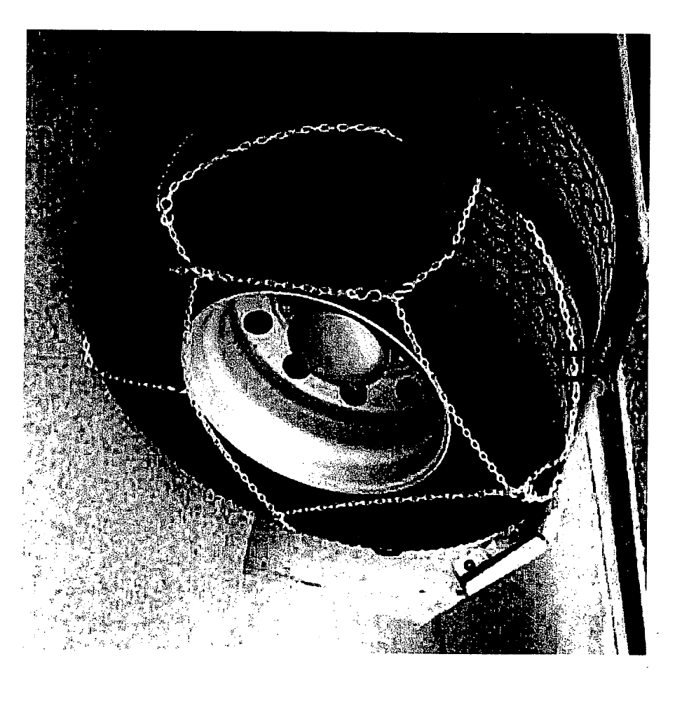

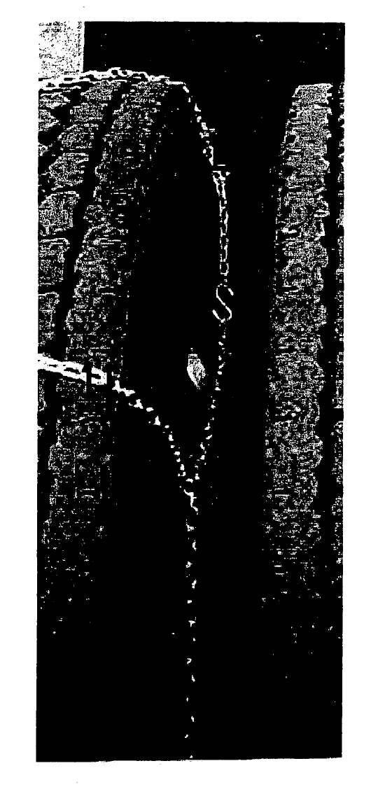

### BACKGROUND—CROSS-REFERENCE TO RELATED APPLICATIONS

This application claims the benefit of Provisional Patent Application Ser. No. 60/462,810, filed on Apr. 14, 2003 and Provisional Patent Application Ser. No. 60/536,234, filed on May 14, 2004.

### BACKGROUND—FIELD OF THE INVENTION

This invention caters to the safety needs of the transportation industry, specifically, as a way for tractor-trailers, and any other vehicle with dual tire assemblies, to increase traction, when driving on icy and snowy road conditions. This system may also be adapted for muddy roads by using a specially-formulated pads for just such an application.

An alternative embodiment addresses single tire applications.

### BACKGROUND—PRIOR ART

There currently exists on the market, sets of chains or wire cables that wrap around the tires, but they are cumbersome to use and, with regards to the chains, are very heavy, and all this, at the worst possible time that you would ever want to mess with them, during a blizzard on the side of a highway up in the mountains, and yet another problem that a driver has with this, is that he cannot drive with the chains on dry pavement, so he has to remove them before he can continue, lest he “burns” them, if he tries to drive this way with them for too long. There also exists on the market a mechanical device that is installed on the vehicle with chains that rotate under the tires and thus provide extra traction, but this is an expensive alternative.

Objects and Advantages

The Traction Pad system addresses those issues, by providing simple, economical, light-weight, easy to handle and quick to install traction pads.

These pads:

stack one upon the other like dishes, for easy storage,

can be made of any variety of single materials, or a combination of materials, such as plastics, rubbers, metals, and cardboard with the purpose of providing extra traction against ice and snow,

are shaped as such, to fit the contour of the dual tires, both across the breadth of the treads and following the radial curve along the tread.

(Another style would be shaped in simple circular fashion, with the diameter of the pad equal to the width of the dual tire assembly,)

may be made a little flexible or kept rigid,

are quickly inserted, with one or more, per pad, of easy to install fastening materials,

are also secured by spacers that keep the pads properly spaced in relation to each other,

the fastening materials are fastened from the traction pad to a belt with hooks, or a chain that wrap around the dual-tire rim at the hub-center between the two tires of the set,

this belt or chain may remain on the rim/hub for the entire winter season, even when not in use, so as to eliminate one step in the process of installing the said traction pads,

the pad has an easily accessible hook for which to fasten with a fastener, and a hole in the pad to allow access for a hand to reach in between the tires to fasten to the belt or chain at the rim/hub,

are designed with the ability, either in the traction pad, the fastener, or the harness belt, to keep the pads taut against the tires, by means from a group comprising of springs or heavy elastics,

a disposable traction pad, made of biodegradable material, making it so that a driver would not need to worry about burning the pad on dry pavement, being inexpensive enough to replace, and being environmentally friendly,

a special application traction pad, designed with deeper treads for use in muddy situations.

List of Reference Numerals

1—dual tire assembly

2—rim at hub

3—harness belt

5—fastener

6—traction pad

7—spacer

8—single tire

9—inner harness

10—outer harness

11—chain or cable

Photographs

Photo #1

Four traction pads (6) are shown here, installed on the dual tire assembly (1). Note the spacer (7) connecting the top, front traction pad to the lower one. Although you can only see one spacer in this photo, the assembly has spacers connecting all the traction pads together.

These traction pads are made for illustration purposes only, to show the shape and how it fits on the tires. Actual traction pads may look like these but would be made of materials that would be able to withstand the rigors of the task. Materials such as aluminum, hard rubber, fiberglass come to mind as well as, for a disposable variety, heavy biodegradable fiberboard, such as the type used for egg crates.

Photo #2

Shows a close-up of the traction pad (6) and a look at the rim at hub (2), between the dual tire assembly. The fasteners (5) can hardly be seen, but are situated there, and serve to connect the traction pad to the harness belt (3). A spacer (7) is also shown. For illustration purposes, I have used chains for both the spacers (7) and the harness belt (3) and a bungee cord for the fasteners (5), but any material the would be able to withstand the rigors of the task at hand will do. Although in this illustration, I gave the task for elasticity to the fastener, using bungee cords, in actuality, any or all of these following parts, the traction pad, the harness belt, or the fastener, may have incorporated in the design, a means for some elasticity, such as springs or rubber, so that the traction pad may remain taut against the tires.

Photo #3

Shows a stack of four traction pads (6). Though these are handmade for illustration purposes, in actuality the manufactured traction pads will stack better.

Photo #4

Shows the alternative embodiment. The dual tire assembly (1) is shown but this embodiment is for single tires (8). The outer harness (10) is made of chain for illustration purposes. Actually, heavy rubber with rings or hooks comes to mind as a likely candidate for the task.

The chains or cables (11) are shown running across the tread of the tire, both straight across and diagonal. This embodiment looks very much like systems already on the market, but I am claiming the novelty of having the parts separated for easier handling.

Photo #5

Shows the rim at hub (2) situated between the two tires. The inner harness (9) is fastened around the hub, and I used chains, here, for illustration purposes, but any durable material would do. Preferably some material that would be able to stay installed on the rim for the entire winter season, that would be silent and lightweight. The chains or cables (11) are shown here crossing the tread of the single outer tire (8). Please disregard the s-hooks that I used here for illustration purposes. Actual materials would be such that they would be able to withstand the task at hand and remain in place the whole time.

Somewhere, in this assembly, although not actually found on existing chains on the market, a means for elasticity, such as rubber or springs, may be incorporated thin, either the outer harness, the inner harness, or the chains/cables.

### SUMMARY OF THE INVENTION

The Traction Pad allows for an easy and quick way for a truck driver to add extra traction to his tires, during those times, when he encounters icy or snowy conditions on the road. Both light-weight and stack able, for easy handling, and quick strap installation, will have the driver back in the warmth and safety of his truck cab that much sooner.

### DESCRIPTION—MAIN EMBODIMENT

The Traction Pad is made of a material that would increase traction on the road for his vehicle during icy or snowy conditions. It can be made of rubber, metal, fiberglass, plastic and heavy cardboard or paperboard, among other possible materials.

The traction pad would be shaped to fit the contour of the tire, both along the radial and across the treads of both tires, actually dipping in between the dual tires, as a way of keeping the pad in place.

If the pads are made of a disposable, biodegradable material, he need not worry about burning them on dry pavement, because these would be environmentally friendly.

Operation—Main Embodiment

When a truck driver encounters snowy or icy road conditions, he needs to have that extra traction in the quickest possible way. With the belt already installed at the center, between the dual tire assembly, all he has to do now is bring out the light-weight pads, and fasten them on.

Similarly, they are just as quickly and easily removed.

This extra agility will be really appreciated on roads where it s icy for a little while, and then the roads are clear again, and then, it s icy again, and then the roads are clear again, and so on and so forth.

The ease and speed with which to make the necessary transitions will make the driver s life that much easier.

The biodegradable variety would be appreciated in this aforementioned situation, because burning the traction pads on dry pavement would not be such a big deal. They would be cost effective, and not harm the ecology, and would eliminate the danger of the stopping on the side of the road to remove them.

Description and Operation—Alternative Embodiments

Another style would serve the same purpose and have the same advantages as the main embodiment, but would accommodate single tires, thus broadening the variety of vehicles that may use this, including the steer tires of tractor-trailers. Once fully installed, this alternative embodiment closely resembles existing chains and cables that exist on the market, so the novelty of this embodiment lies in the fact that the various parts are separated for easier handling.

In this alternative embodiment, there would be both an inner and an outer harness, with chains or cables that connect to them across the tire tread, both straight across and diagonal. The harnesses would be made strong material, capable of withstanding the rigors of the task, and would have incorporated either within the harnesses or the chains or cables, a means to keep the chains taut against the tire, such as springs, elastics or rubber.

The inner harness is open-ended and is clamped around the wheel s axle, and then the chains are hooked onto the inner harness s hooks. The outer harness is then hooked onto the chains coming across the tread of the tire. The assembly is complete.

The ease of installation and removal with just a few chains per tire will keep a vehicle well tractioned for those emergencies, till they get to a safe haven.

Conclusion, Ramifications, and Scope

Thus the reader will see that the traction pad provides a quicker and thus safer, easier to handle, and lightweight means to provide extra traction on our roads, during icy and snowy road conditions.

One would not need to be a Rambo to handle them and one would be able to get back in the warmth and safety of their truck cab that much sooner.

it minimizes the amount of time needed for a driver to be outside by a highway in bad weather, (sometimes, just one or two pads would be enough to move the truck out of harm s way! And then the driver may install the rest of them in a safer area)

it gives the driver that extra traction, where and when it s needed

it is simple to handle

it is inexpensive to acquire, relative to other prior art methods

it allows for burning by use of a disposable, biodegradable variety

standardized pads could be made available most anywhere

a special design of traction pad, using deeper treads, for muddy situations.

1- A method for providing extra traction for a vehicle when encountering icy or heavy snowy conditions, comprising the steps of:
a. upon the drivers pulling on the side of the highway, he proceeds to distribute a plurality of traction pads to each set of tires, that he desires to set up, and
b. the harness belt already in place for the winter season, situated between the dual tire assemblies, at the rim, said driver proceeds to place said traction pads on the said tires, and
c. said driver connects said traction pads to said harness using a means for fastening, either independent or incorporated in the design of said harness and/or said traction pad,
Whereby said driver can continue driving said vehicle, however slowly, to a safe haven.

2- The method of claim 1, whereby said traction pads are lightweight and stack able for ease of handling and storage.

3- The method of claim 1, whereby said traction pads are kept taut against said tire by use of a means coming from a group comprising of springs, elastics, rubber, either incorporated in the said harness, or in said fasteners or in said traction pads.

4- The method of claim 1, whereby said driver connects said traction pads to each other using a means for spacing, either independent or incorporated in the design of the said traction pads that keep said pads properly spaced.

5- The method of claim 1, whereby special traction pads having deeper treads for muddy applications, can also be available.

6- The method of claim 1, whereby an alternative embodiment, designed for single tires, comprising the steps of:
a. upon the drivers pulling on the side of the highway, he proceeds to distribute the inner harness, the outer harness and the traction able material coming from a group comprising of chains or cables, to each set of tires, that he desires to set up, and
b. said driver installs said inner harness around the axle of said tire, and
c. said driver hooks one end of said traction able material to said inner harness, and
d. said driver hooks other end of said traction able material, now crossing the tread of said tire, both straight across and diagonally, to said outer harness.

7- The method of claim 6, whereby said traction able materials are kept taut against said tire by use of a means coming from a group comprising of springs, elastics, rubber, either independent or incorporated in said inner harness, or said outer harness or in said traction able materials.

8- The method of claim 6, whereby the novelty of this method over existing prior art, would be the ease of handling of the now separated parts.

9- A device that is placed against dual tires for providing extra traction during icy and snowy road conditions, comprising:
a. said device heretofore called a traction pad, made of lightweight, durable material, designed to cover as much as the entire width of the dual tire assembly, and curved to follow the radii of said tire assembly, and large enough so that a plurality of said traction pads would provide the needed traction, yet small enough to be easily handled, and made of traction able materials that will grab at snow and ice on the road, and
b. a harness belt that installs at the rim of the dual tire assembly, between the dual tires, and may remain there the entire winter season, so as to eliminate one step in the installation, and made of a durable material, that will serve as an anchor to fasten said traction pads to, and
c. a fastener, made with strong materials, that may be independent, or incorporated into the design of the said harness or incorporated into the design of said traction pad and serves to connect said traction pads to said harness.

10- The device of claim 9, whereby said device may be made of biodegradable material for a disposable variety that would be environmentally friendly.

11- The device of claim 9, whereby said traction pads are made lightweight and stack able for ease of handling and storage.

12- The device of claim 9, whereby a means for keeping said traction pads taut against said tire assembly comprising of materials from a group consisting of springs, elastics, or rubber, which may be independent or may be incorporated in the design of said harness or may be incorporated in the design of said traction pad.

13- The device of claim 9, whereby a spacer that may either be independent, or incorporated into the design of said traction pad and serves to connect said traction pads, made of durable material, that keeps said traction pads properly spaced around said tire assembly,

14- The device of claim 9, whereby special designed traction pads with deeper treads, for muddy situations, may also be available,

15- The device of claim 9, whereby an alternative embodiment would be one that is placed against single tires for providing extra traction during icy and snowy road conditions, comprising:
a. an inner harness that installs around the axle of said tire,
b. said inner harness having means for connecting traction able material coming from a group comprising of chains or cables,
c. said traction able material that crosses over the tread of said tire both straight across and diagonally,
d. an outer harness having a means to connect to the other end of said traction able materials,

16- The device of claim 15, whereby would be included, a means from a group comprising of springs, elastics, rubber, either independent or incorporated in any of the above aforementioned parts, to allow for said traction able materials to be taut against said tire.

17- The device of claim 15, whereby the novelty of this method over existing prior art, would be the ease of handling of the now separated parts.
